(19) United States
(12) Patent Application Publication
(10) Pub. No.: US 2005/0203781 A1
(43) Pub. Date: Sep. 15, 2005

(54) Vision care and protection policy

(75) Inventors: Christy Wilson, Smiths, AL (US); Katherine Gant, Columbus, GA (US); Mark C. Massey, Auburn, AL (US); Tom Morey, Columbus, GA (US); JoAnn King, Columbus, GA (US); Deborah Grantham, Woodland, GA (US); Wendy Herndon, Columbus, GA (US); Karen Riedel, Phenix City, AL (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: AFLAC

(21) Appl. No.: 11/137,242

(22) Filed: May 24, 2005

Related U.S. Application Data
(60) Provisional application No. 60/634,883, filed on Dec. 10, 2004.

(51) Int. Cl. G06F 17/60

(52) U.S. Cl. 705/4; 705/2

(57) ABSTRACT

A vision protection policy providing both a routine eye care benefit and one or more of the following benefits: (1) an eye condition benefit; (2) an eye surgery benefit; and (3) a permanent visual impairment benefit is provided. Methods of offering the vision protection policy, of issuing the vision protection policy to a qualified insured, and of processing a vision protection policy claim received from a policy participant are also provided.

### CROSS-REFERENCE TO PROVISIONAL APPLICATION

The present application claims priority from U.S. Provisional Application No. 60/634,883 filed Dec. 10, 2004, the contents of which are hereby incorporated herein by reference in their entirety.

### BACKGROUND OF THE INVENTION

Current eye care policies typically provide policy holders with annual eye examinations and free or reduced-cost vision correction products, such as eyeglasses or contact lenses. However, there is a need for improved insurance policies that provide additional types of vision-related coverage.

### BRIEF SUMMARY OF THE INVENTION

Generally described, various embodiments of the present invention provide an improvement over the known prior art by providing eye care policies that provide policy holders with vision-related coverage that is in addition to routine coverage for eye examinations and/or vision correction products. Methods of offering, of issuing and of processing claims received under these vision correction policies are also provided.

A vision protection policy according to embodiments of the present invention provides an eye examination benefit and an eye condition benefit that provides for one or more eye condition benefit payments to be made in response to a policy participant being diagnosed with a particular eye disease or disorder. In one embodiment, this vision protection policy further provides a vision correction benefit.

A vision protection policy according to other embodiments of the present invention provides a vision correction benefit and an eye condition benefit that provides for one or more eye condition benefit payments to be made in response to a policy participant being diagnosed with a particular eye disease or disorder.

A vision protection policy according to yet other embodiments of the present invention provides an eye examination benefit and an eye surgery benefit that provides for one or more eye surgery benefit payments to be made to a policy participant in response to the policy participant undergoing a surgical procedure related to a particular eye disease or disorder. In one embodiment, this vision protection policy further provides a vision correction benefit.

A vision protection policy according to embodiments of the present invention provides a vision correction benefit and an eye surgery benefit that provides for one or more eye surgery benefit payments to be made to a policy participant in response to the policy participant undergoing a surgical procedure related to a particular eye disease or disorder.

A vision protection policy according to other embodiments of the present invention provides an eye examination benefit and a permanent visual impairment benefit that provides for at least one payment to be made in response to a policy participant being diagnosed with a visual impairment for which there is no, or substantially no, reasonable medical prognosis of recovery.

According to another aspect of the present invention, a method of issuing a vision protection policy is provided. One embodiment of the method includes the steps of (1) receiving applicant data relating to a prospective policy participant; (2) determining, based at least in part on the applicant data, whether the prospective policy participant qualifies for the vision protection policy; and (3) issuing the vision protection policy to a policy participant, wherein the policy participant is comprised of the prospective policy participant determined, in step (2), to qualify for the vision protection policy. In this embodiment, the vision protection policy provides a routine eye care benefit, and one or more of an eye condition benefit, an eye surgery benefit, or a permanent visual impairment benefit.

According to another aspect of the invention, a method of processing a vision protection policy claim is provided. One embodiment of the method includes the steps of (1) receiving a vision protection policy claim from a policy participant; (2) determining whether the policy participant has incurred one or more expenses relating to routine eye care; (3) determining whether the policy participant has been diagnosed with an eye disease or disorder; (4) determining whether the policy participant has undergone a surgical procedure related to an eye disease or disorder; (5) determining whether the policy participant has been diagnosed with a visual impairment for which there is no, or substantially no, reasonable prognosis of recovery; and (6) providing some combination of a routine eye care benefit, an eye condition benefit, an eye surgery benefit, and a permanent visual impairment benefit based on the determinations made in steps (2) through (5).

According to yet another aspect of the present invention, a method of offering a vision protection policy is provided. One embodiment of the method includes the step of providing a vision protection policy application, wherein the vision protection policy provides a routine eye care benefit, and one or more of an eye condition benefit, an eye surgery benefit, or a permanent visual impairment benefit.

### BRIEF DESCRIPTION OF THE DRAWING(S)

Having thus described the invention in general terms, reference will now be made to the accompanying drawings, which are not necessarily drawn to scale, and wherein:

FIG. 1 is a flow chart illustrating a method of issuing a vision protection policy according to an embodiment of the present invention; and

FIG. 2 is a flow chart illustrating a method of processing a vision protection policy claim according to a particular embodiment of the present invention.

### DETAILED DESCRIPTION OF THE INVENTION

The present invention now will be described more fully with reference to the accompanying drawings, in which some, but not all embodiments of the invention are shown. Indeed, this invention may be embodied in many different forms and should not be construed as limited to the embodiments set forth herein. Rather, these embodiments are provided so that this disclosure will satisfy applicable legal requirements. Like numbers refer to like elements throughout.

As will be appreciated by one skilled in the art, embodiments of the present invention may be embodied as a method, a data processing system, or a computer program product. Accordingly, the present invention may take the form of an entirely hardware embodiment, an entirely software embodiment, or an embodiment combining software and hardware aspects. Furthermore, the present invention may take the form of a computer program product on a computer-readable storage medium having computer-readable program instructions (e.g., computer software) embodied in the storage medium. More particularly, the present invention may take the form of web-implemented computer software. Any suitable computer-readable storage medium may be utilized including hard disks, CD-ROMs, optical storage devices, or magnetic storage devices.

The present invention is described below with reference to block diagrams and flowchart illustrations of methods, apparatuses (i.e., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Vision Protection Policy

A vision care and protection policy (also referred to as a “vision policy” or a “vision protection policy”) according to a particular embodiment of the invention comprises both a routine eye care benefit and one or more of the following benefits: (1) an eye condition benefit; (2) an eye surgery benefit; and (3) a permanent visual impairment benefit. Exemplary routine eye care benefits, eye condition benefits, eye surgery benefits, and permanent visual impairment benefits are described below.

Routine Eye Care Benefits

In various embodiments of the invention, a routine eye care benefit includes an eye examination benefit and/or a vision correction benefit. An eye examination benefit provides, for example, for a predetermined payment to be made when a charge is incurred for an eye examination for a person covered by the vision policy (a “policy participant”). In various embodiments, this payment may be made directly to the policy participant. In certain embodiments of the invention, the vision policy may provide for policy participants to receive one or more eye examinations at no cost, or substantially no cost, to the policy participant.

A vision correction benefit provides, for example, for a predetermined vision correction payment to be made when a policy participant purchases one or more vision correction materials. In one embodiment of the invention, the vision correction materials may include eyeglasses and/or contact lenses. The vision correction payment may be made, for example, directly to the policy participant. In certain embodiments of the invention, the vision policy may provide for policy participants to receive the vision correction materials at no cost, or substantially no cost, to the policy participant.

Also, in various embodiments of the invention, the vision correction benefit provides for a vision correction payment to be made to the policy participant in response to the policy participant undergoing a medical procedure to improve said policy participant's vision. Such a medical procedure may include, for example, refractive error correction surgery.

Eye Condition Benefit A typical eye condition benefit provides for one or more eye condition benefit payments to be made in response to a policy participant being diagnosed with a particular eye disease or eye disorder. In various embodiments of the invention, such eye diseases and disorders may include, for example: glaucoma, proliferative diabetic retinopathy, macular degeneration, retinal detachment, and retinitis pigmentosa.

In certain embodiments of the invention, the vision policy provides that the eye condition benefit payments are to be paid regardless of other insurance coverage (and preferably regardless of any insurance coverage) that the policy participant may have for medical care related to the particular eye disease or disorder at issue. For example, in one embodiment, if the policy participant has other insurance coverage that would pay for treatment of a particular eye disease or disorder, any payments to be made under the vision policy would still be made if the policy participant were diagnosed with the particular eye disease or disorder. In a particular embodiment of the invention, the one or more eye condition benefit payments include a payment of a pre-defined amount (e.g., $1,000) to be made to the policy participant.

Eye Surgery Benefit

A typical eye surgery benefit provides for one or more eye surgery benefit payments to be made in response to a policy participant undergoing a surgical procedure related to a particular eye disease or disorder. The following table includes an exemplary listing of one-time eye surgery benefit payments to be made to a policy participant in response to the policy participant undergoing a corresponding listed surgical procedure:

SCHEDULE OF OPERATIONS

| | |
|---|---|
| Cornea Transplant | $1,500 |
| Cataracts | |
| Removal | $800 |
| Discission | $400 |
| Glaucoma | |
| Fistulization of sclera | $800 |
| Iriodotomy/Iridectomy | $400 |
| Eye Cancer and Tumors | |
| Radiation implant, with removal | $1,200 |
| Destruction by Photocoagulation | $800 |
| Destruction by Cryotherapy | $800 |
| Excision of gland tumor | $800 |
| Retinopathy | |
| Destruction by Photocoagulation | $800 |
| Destruction by Cryotherapy | $800 |
| Retinal Detachment Repair | $1,000 |
| Miscellaneous Eye Surgeries | |
| Exenteration of orbit | $1,500 |
| Keratoprosthesis | $1,500 |
| Orbitotomy | |
| with bone flap | $1,500 |
| without bone flap | $1,000 |
| Evisceration of ocular contents | $800 |
| Enucleation of eye | $800 |
| Insertion of ocular implant | $800 |
| Removal of blood clot, | |
| anterior segment of eye | $800 |
| Removal of foreign body | |
| from anterior chamber or lens | $800 |
| external eye | $50 |
| Repair of laceration, cornea, | $400 |
| sclera, or conjunctiva | |
| Cilary Body destruction | $400 |
| Excision of lesion, other | $200 |
| than chalazion | |
| Excision of chalazion | $100 |

In certain embodiments of the invention, the vision policy provides that eye surgery benefit payments are to be paid regardless of other insurance coverage (and preferably regardless of any insurance coverage) that the policy participant may have for the surgical procedure at issue. For example, in one embodiment, if the policy participant has other insurance coverage that would pay for the removal of cataracts in one of the policy participant's eyes, the provider of the vision policy would still make a payment of $800 to the policy participant.

Permanent Visual Impairment Benefit

A permanent visual impairment benefit according to one embodiment of the invention provides for at least one visual impairment payment to be made in response to the policy participant being diagnosed with a visual impairment for which there is no, or substantially no, reasonable medical prognosis of recovery. In particular, in one embodiment of the invention, the provider of the vision policy will pay the indemnity amounts listed below for the specific level (or levels) of visual impairment that apply to the policy participant's diagnosed stage of visual impairment.

| | | | | | MAXIMUM |
|---|---|---|---|---|---|
| VISUAL IMPAIRMENT | | | | | CUMULATIVE |
| LEVEL | TOTAL PER LEVEL | | | | BENEFIT PER EYE |
| (Level 1) - Severe | $750 | | | | $750 |
| (Level 2) - Profound | | +$1,750 | | | $2,500 |
| (Level 3) - Near-Total | | | +$2,500 | | $5,000 |
| (Level 4) - Total | | | | +$5,000 | $10,000 |

As may be understood from the above table, in certain embodiments, if a policy participant is diagnosed with a Level 2, 3, or 4 visual impairment, benefits for previously unpaid lower levels of visual impairment will be paid in addition to benefits for the level diagnosed. For example, if a policy participant is diagnosed with a profound (Level 2) visual impairment, in the embodiment of the invention described above, the participant would receive a payment of $2,500 (which is the sum of (1) a payment of $1,750 for a Level 2 visual impairment and (2) a payment of $750 for a Level 1 visual impairment). In one embodiment of the invention, each level of visual impairment is payable up to a maximum of once per eye, per policy participant.

In one embodiment of the invention, a policy participant's level of visual impairment is determined as follows:
(LEVEL 1) SEVERE VISUAL IMPAIRMENT: Maximal visual acuity, after correction, of 20/200 or less, or a total diameter of the visual field in that eye of 20 degrees or less.
(LEVEL 2) PROFOUND VISUAL IMPAIRMENT: Maximal visual acuity, after correction, of 20/500 or less, or a total diameter of the visual field in that eye of 10 degrees or less.
(LEVEL 3) NEAR-TOTAL VISUAL IMPAIRMENT: Maximal visual acuity, after correction, less than 20/1000, or a total diameter of the visual field in that eye of 5 degrees or less.
(LEVEL 4) TOTAL VISUAL IMPAIRMENT: Complete loss of vision with no remaining perception of light, or loss of the natural eye.

In certain embodiments of the invention, the vision policy provides that visual impairment payments are to be paid regardless of other insurance coverage (and preferably regardless of any insurance coverage) that the policy participant may have that is related to the visual impairment at issue.

Method of Issuing Vision Protection Policy

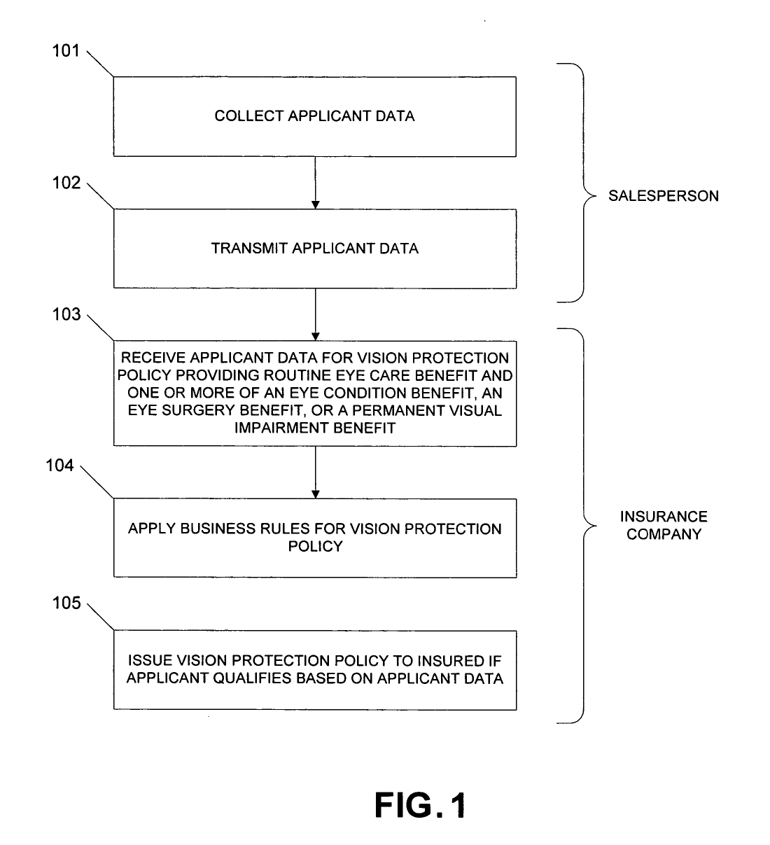

FIG. 1 illustrates the steps taken when issuing the above described vision protection policy according to one embodiment of the present invention. As shown, in one embodiment the process of issuing a vision protection policy begins at Step 101 when a sales person collects Applicant data from a prospective policy participant and enters it into his or her handheld device. The Applicant data can then, in Step 102, be uploaded from the handheld device to the Insurance Company's computer. The handheld device may be any mobile device, such as a mobile phone, a portable data assistant (PDA), or a mobile personal computer (PC), to name a few. The Applicant data collected may include, for example, the prospective policy participant's name, address or medical history, and/or other types of insurance coverage owned by the prospective policy participant.

In other embodiments, the process could likewise begin with a prospective policy participant entering his or her own Applicant data directly into an application form provided by the Insurance Company, and sending the application form to the Insurance Company. The application form could be in hard copy, requiring, for example, that the prospective policy participant enter the Applicant data by hand, and then mail or fax the form to the Insurance Company. The Applicant data could then be entered into the Insurance Company computer by, for example, an Insurance Company employee. Alternatively, the application form could be provided over the Internet on a Web site operated by the Insurance Company, or by some other company affiliated with the Insurance Company. In this case the prospective policy participant could merely enter the data into the online version of the application form and then send the data electronically to the Insurance Company computer. In yet another embodiment, the prospective policy participant may contact an Insurance Company operator directly, by phone or by other means, and communicate the Applicant data to the operator, who will then enter the data into the Insurance Company computer.

Once the Insurance Company computer has received the Applicant data, in Step 103, a Vision Protection Policy Issuance Application on the Insurance Company computer applies various business rules, which are stored in a database on the Insurance Company computer, to the Applicant data to determine whether the prospective policy participant qualifies for the vision protection policy (Step 104). This may include, for example, checking the applicant's name and address to determine whether they are valid, authenticating the applicant to ensure that the applicant is who he/she claims to be, determining whether the applicant is financially responsible based on a credit or payment history check, for example, determining whether the applicant's medical history and status are within risk parameters of the policy, determining whether the applicant has pre-existing conditions that should be excluded from policy coverage, determining whether the applicant is of legal age to enter a binding contract in the State in which a policy is sought, etc.

Upon a determination that the prospective policy participant does qualify for the vision protection policy, in Step 105 the Vision Protection Policy Issuance Application issues the vision protection policy to the policy participant. The actual policy can then be sent, for example, electronically, by mail, by fax or delivered by hand, to the policy participant.

Method of Processing a Claim Under the Vision Protection Policy

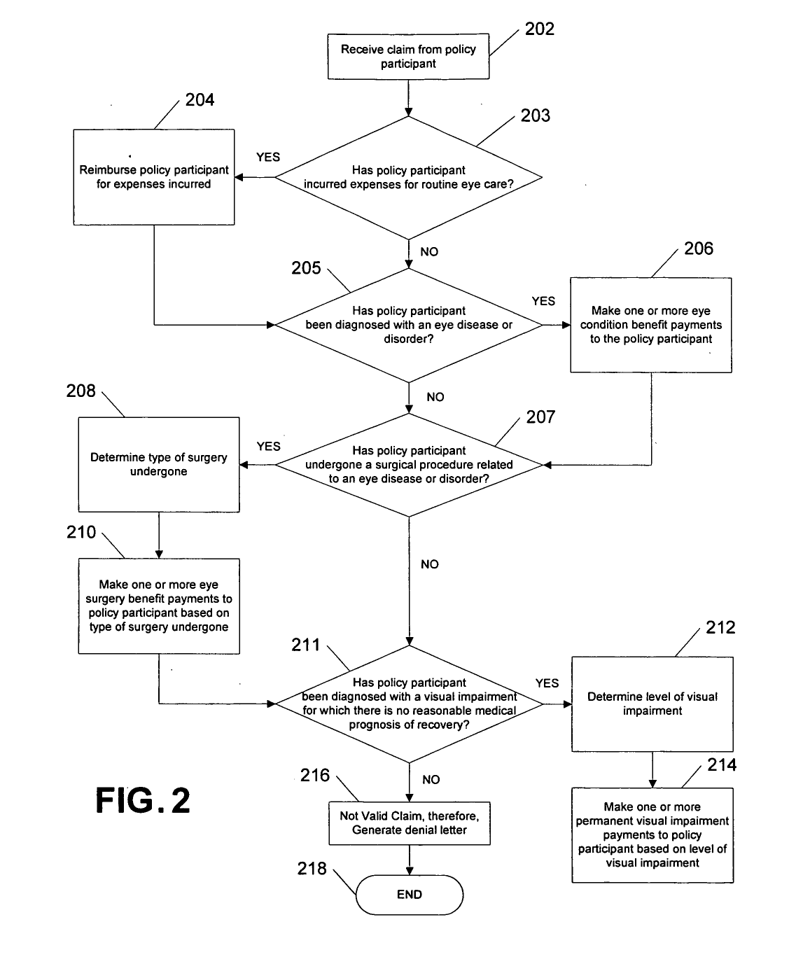

FIG. 2 illustrates the steps taken when processing a claim received from a vision protection policy participant according to various embodiments of the present invention. As shown, in Step 202 the Insurance Company first receives a claim, for example by phone, mail, fax, or electronically, from a policy participant. Once received, the Insurance Company, in one embodiment, first determines, based on the claim received, whether the policy participant has incurred an expense for routine eye care (Step 203). The expense may include, for example, the cost of an eye examination, vision correction materials, or of undergoing a medical procedure to improve the policy participant's vision. Where it is found that the policy participant has in fact incurred one of the routine eye care expenses covered by the vision protection policy, the Insurance Company, in one embodiment, provides, in Step 204, at least partial reimbursement to the policy participant for the expenses incurred. The amount of reimbursement and the extent that these expenses are covered varies for different embodiments of the present invention. For example, in one embodiment, the policy participant is not reimbursed for any expenses incurred when undergoing a medical procedure to improve his or her vision; while in other embodiments, the policy participant may receive partial or full reimbursement for such expenses.

In Step 205 the Insurance Company determines whether the policy participant has been diagnosed with an eye disease or disorder for which coverage is provided by the vision protection policy. As discussed above, the diseases or disorders that are covered by the vision protection policy may include, for example, glaucoma, proliferative diabetic retinopathy, macular degeneration, retinal detachment, or retinitis pigmentosa. If the policy participant has been diagnosed with one of the covered diseases or disorders, the Insurance Company, in Step 206, makes one or more eye condition benefit payments to the policy participant. In one embodiment, the one or more eye condition benefit payments include a payment of a pre-defined amount (e.g., $1000).

In Step 207, the Insurance Company, in one embodiment, then determines whether the policy participant has undergone a surgical procedure related to an eye disease or disorder. If the policy participant has undergone a surgical procedure related to an eye disease or disorder, in Steps 208 and 210 the Insurance Company first determines what type of surgical procedure was undergone, and then makes one or more eye surgery benefit payments to the policy participant based on the type of surgical procedure undergone. For example, where the policy participant has undergone surgery to remove cataracts, the Insurance Company may provide an eye surgery benefit payment of $800.

In Step 211 the Insurance Company, according to one embodiment of the present invention, determines whether the policy participant has been diagnosed with a visual impairment for which there is no, or substantially no, reasonable medical prognosis of recovery. Where the policy participant has been so diagnosed, in Steps 212 and 214 the Insurance Company first determines the level of visual impairment that has been diagnosed, and then makes at least one visual impairment payment to the policy participant based on the level of visual impairment. For example, as discussed above, a policy participant diagnosed with a Level 1 impairment (i.e., severe visual impairment) may receive up to $750 per eye; while a policy participant diagnosed with a Level 4 impairment (i.e., total visual impairment) may receive up to $10,000 per eye.

If it is determined that the policy participant has not incurred expenses for routine eye care, been diagnosed with a disease or disorder, undergone a surgical procedure related to an eye disease or disorder, or been diagnosed with a visual impairment for which there is no, or substantially no, reasonable prognosis of recovery, the claim received is not valid and a denial letter is generated, after which the process ends (shown in Steps 216 and 218).

As will be understood by those of ordinary skill in the art, the steps of the process described above need not be performed in the order in which they are described. For instance, it is not necessary that the Insurance Company determine whether the policy participant has been diagnosed with an eye disease or disorder prior to determining whether the policy participant has undergone a surgical procedure or has been diagnosed with a visual impairment, as long as the necessary determinations are made to assess what benefits the policy participant should receive.

### Modificatios and Alternative Embodiments

Many modifications and other embodiments of the invention will come to mind to one skilled in the art to which this invention pertains having the benefit of the teachings presented in the foregoing descriptions. Accordingly, it should be understood that the invention is not to be limited to the specific embodiments disclosed and that modifications and other embodiments are intended to be included within the scope of the appended exemplary inventive concepts. Although specific terms are employed herein, they are used in a generic and descriptive sense only and not for purposes of limitation.

1. A vision protection policy providing:
an eye examination benefit; and
an eye condition benefit that provides for one or more eye condition benefit payments to be made in response to a policy participant being diagnosed with a particular eye disease or disorder.

2. The vision protection policy of claim 1, wherein said particular eye disease or disorder is selected from a group consisting of: glaucoma, proliferative diabetic retinopathy, and macular degeneration.

3. The vision protection policy of claim 1, wherein said particular eye disease or disorder is selected from a group consisting of: retinal detachment, and retinitis pigmentosa.

4. The vision protection policy of claim 1, wherein:
said one or more eye condition benefit payments are to be paid regardless of other insurance coverage that said policy participant may have for medical care related to said particular eye disease or disorder.

5. The vision protection policy of claim 1, wherein said one or more eye condition benefit payments comprises a payment of a pre-defined amount to be made to said policy participant.

6. The vision protection policy of claim 1, wherein said vision protection policy further provides a vision correction benefit.

7. The vision protection policy of claim 1, wherein said eye examination benefit at least partially covers a cost associated with at least one medical examination of said policy participant's eyes.

8. A vision protection policy providing:
a vision correction benefit; and
an eye condition benefit that provides for one or more eye condition benefit payments to be made in response to a policy participant being diagnosed with a particular eye disease or disorder.

9. The vision protection policy of claim 8, wherein said particular eye disease or disorder is selected from a group consisting of: glaucoma, cancer of the eye, proliferative diabetic retinopathy, and macular degeneration.

10. The vision protection policy of Concept 8, wherein said particular eye disease or disorder is selected from a group consisting of: retinal detachment, and retinitis pigmentosa.

11. The vision protection policy of claim 8, wherein:
said one or more eye condition benefit payments are to be paid regardless of other insurance coverage that said policy participant may have for medical care related to said particular eye disease or disorder.

12. The vision protection policy of claim 8, wherein said one or more eye condition benefit payments comprises a payment of a pre-defined amount to be made to said policy participant.

13. The vision protection policy of claim 8, wherein:
said vision correction benefit at least partially covers a cost associated with purchasing one or more vision correction materials to be used by said policy participant.

14. The vision protection policy of claim 13, wherein:
said vision correction benefit provides for a vision correction payment to be made to said policy participant in response to said policy participant undergoing a medical procedure to improve said policy participant's vision.

15. A vision protection policy providing:
an eye examination benefit; and
an eye surgery benefit that provides for one or more eye surgery benefit payments to be made to a policy participant in response to said policy participant undergoing a surgical procedure related to a particular eye disease or disorder.

16. The vision protection policy of claim 15, wherein said surgical procedure is selected from a group consisting of: cornea transplant, cataract removal, cataract discission, and retinal detachment repair.

17. The vision protection policy of claim 15, wherein:
said one or more eye surgery benefit payments are to be paid regardless of other insurance coverage that said policy participant may have for medical care related to said particular eye disease or disorder.

18. The vision protection policy of claim 15, wherein said one or more eye surgery benefit payments comprises a payment of a pre-determined amount to said policy participant.

19. The vision protection policy of claim 15, wherein said vision protection policy further provides a vision correction benefit.

20. The vision protection policy of claim 15, wherein said eye examination benefit at least partially covers a cost associated with at least one medical examination of said policy participant's eyes.

21. A vision protection policy providing:
a vision correction benefit; and
an eye surgery benefit that provides for one or more eye surgery benefit payments to be made to a policy participant in response to said policy participant undergoing a surgical procedure related to a particular eye disease or disorder.

22. The vision protection policy of claim 21, wherein said surgical procedure is selected from a group consisting of: cornea transplant, cataract removal, cataract discission, and retinal detachment repair.

23. The vision protection policy of claim 21, wherein:
said one or more eye surgery benefit payments are to be paid regardless of other insurance coverage that said policy participant may have for medical care related to said particular eye disease or disorder.

24. The vision protection policy of claim 21, wherein said one or more eye surgery benefit payments comprise a payment of a pre-determined amount to said policy participant.

25. The vision protection policy of claim 21, wherein:
said vision correction benefit at least partially covers a cost associated with purchasing one or more vision correction materials to be used by said policy participant.

26. The vision protection policy of claim 25, wherein:
said vision correction benefit provides for a vision correction payment to be made to said policy participant in response to said policy participant undergoing a medical procedure to improve said policy participant's vision.

27. A vision protection policy providing:
an eye examination benefit; and
a permanent visual impairment benefit that provides for at least one payment to be made in response to a policy participant being diagnosed with a visual impairment for which there is no, or substantially no, reasonable medical prognosis of recovery.

28. The vision protection policy of claim 27, wherein said permanent visual impairment benefit provides for a first particular set of one or more payments to be made to said policy participant in response to said policy participant being diagnosed with a first type of visual impairment.

29. The vision protection policy of claim 28, wherein said first type of visual impairment is a severe visual impairment.

30. The vision protection policy of claim 28, wherein said first type of visual impairment is defined by said policy participant having a maximal visual acuity in a particular eye, after correction, of 20/200 or less, or a total diameter of the visual field in said particular eye of 20 degrees or less.

31. The vision protection policy of claim 28, wherein said permanent visual impairment benefit provides for a second particular set of one or more payments to be made to said policy participant in response to said policy participant being diagnosed with a second type of visual impairment.

32. The vision protection policy of claim 31, wherein said first particular set of one or more payments is different from said second particular set of one or more payments.

33. The vision protection policy of claim 31, wherein said second type of visual impairment is a profound visual impairment.

34. The vision protection policy of claim 31, wherein said second type of visual impairment is defined by said policy participant having a maximal visual acuity in a particular eye, after correction, of 20/500 or less, or a total diameter of the visual field in said particular eye of 10 degrees or less.

35. The vision protection policy of claim 31, wherein said permanent visual impairment benefit provides for a third particular set of one or more payments to be made to said policy participant in response to said policy participant being diagnosed with a third type of visual impairment.

36. The vision protection policy of claim 35, wherein said third type of visual impairment is a near-total visual impairment.

37. The vision protection policy of claim 35, wherein said third type of visual impairment is defined by said policy participant having a maximal visual acuity in a particular eye, after correction, of 20/1000 or less, or a total diameter of the visual field in said particular eye of 5 degrees or less.

38. The vision protection policy of claim 35, wherein said permanent visual impairment benefit provides for a fourth particular set of one or more payments to be made to said policy participant in response to said policy participant being diagnosed with a fourth type of visual impairment.

39. The vision protection policy of claim 38, wherein said fourth type of visual impairment is a total visual impairment.

40. The vision protection policy of claim 38, wherein said fourth type of visual impairment is defined by said policy participant having a complete loss of vision in a particular eye with no remaining perception of light, or the loss of said particular eye.

41. The vision protection policy of claim 27, wherein:
said permanent visual impairment benefit is to be paid regardless of other insurance coverage that said policy participant may have for medical care related to said visual impairment.

42. The vision protection policy of claim 27, wherein said vision protection policy further provides a vision correction benefit.

43. The vision protection policy of claim 27, wherein said eye examination benefit at least partially covers a cost associated with at least one medical examination of said policy participant's eyes.

44. A method of issuing a vision protection policy, said method comprising the steps of:
receiving applicant data related to a prospective policy participant;
determining, based at least in part on said applicant data, whether said prospective policy participant qualifies for said vision protection policy; and
issuing said vision protection policy to a policy participant, wherein said policy participant is comprised of said prospective policy participant determined to qualify for said vision protection policy,
wherein said vision protection policy provides a routine eye care benefit, and one or more of an eye condition benefit, an eye surgery benefit, or a permanent visual impairment benefit.

45. The method of claim 44, wherein said routine eye care benefit of said vision protection policy is comprised of an eye examination benefit, said eye examination benefit at least partially covering a cost associated with at least one medical examination of said policy participant's eyes.

46. The method of claim 45, wherein said routine eye care benefit of said vision protection policy is further comprised of a vision correction benefit, wherein said vision correction benefit at least partially covers a cost associated with purchasing one or more vision correction materials to be used by said policy participant, and wherein said vision correction benefit further provides for a vision correction payment to be made to said policy participant in response to said policy participant undergoing a medical procedure to improve said policy participant's vision.

47. The method of claim 44, wherein said eye condition benefit of said vision protection policy provides for one or more eye condition benefit payments to be made in response to said policy participant being diagnosed with a particular eye disease or disorder.

48. The method of claim 44, wherein said eye surgery benefit of said vision protection policy provides for one or more eye surgery benefit payments to be made to a policy participant in response to said policy participant undergoing a surgical procedure related to a particular eye disease or disorder.

49. The method of claim 44, wherein said permanent visual impairment benefit of said vision protection policy provides for at least one payment to be made in response to a policy participant being diagnosed with a visual impairment for which there is no, or substantially no, reasonable medical prognosis of recovery.

50. A method of processing a vision protection policy claim, said method comprising the steps of:
(a) receiving a vision protection policy claim from a policy participant;
(b) determining whether said policy participant incurred one or more expenses relating to routine eye care;
(c) determining whether said policy participant has been diagnosed with an eye disease or disorder;
(d) determining whether said policy participant has undergone a surgical procedure related to an eye disease or disorder;
(e) determining whether said policy participant has been diagnosed with a visual impairment for which there is no, or substantially no, reasonable medical prognosis of recovery; and
(f) providing some combination of a routine eye care benefit, an eye condition benefit, an eye surgery benefit, and a permanent visual impairment benefit based on the determinations made in steps (b) through (e).

51. The method of claim 50, wherein said routine eye care benefit provided in step (f) is comprised of an eye examination benefit, said eye examination benefit at least partially covering a cost associated with at least one medical examination of said policy participant's eyes.

52. The method of claim 51, wherein said routine eye care benefit provided in step (f) is further comprised of a vision correction benefit, wherein said vision correction benefit at least partially covers a cost associated with purchasing one or more vision correction materials to be used by said policy participant, and wherein said vision correction benefit further provides for a vision correction payment to be made to said policy participant in response to said policy participant undergoing a medical procedure to improve said policy participant's vision.

53. The method of claim 50, wherein said eye condition benefit provided in step (f) provides for one or more eye condition benefit payments to be made in response to said policy participant being diagnosed with a particular eye disease or disorder.

54. The method of claim 50, wherein said eye surgery benefit provided in step (f) provides for one or more eye surgery benefit payments to be made to a policy participant in response to said policy participant undergoing a surgical procedure related to a particular eye disease or disorder.

55. The method of claim 50, wherein said permanent visual impairment benefit provided in step (f) provides for at least one payment to be made in response to a policy participant being diagnosed with a visual impairment for which there is no, or substantially no, reasonable medical prognosis of recovery.

56. A method of offering a vision protection policy, said method comprising the step of:
providing a vision protection policy application, wherein the vision protection policy provides a routine eye care benefit, and one or more of an eye condition benefit, an eye surgery benefit, or a permanent visual impairment benefit.

57. The method of claim 56, wherein said eye condition benefit of said vision protection policy provides for one or more eye condition benefit payments to be made in response to said policy participant being diagnosed with a particular eye disease or disorder.

58. The method of claim 56, wherein said eye surgery benefit of said vision protection policy provides for one or more eye surgery benefit payments to be made to a policy participant in response to said policy participant undergoing a surgical procedure related to a particular eye disease or disorder.

59. The method of claim 56, wherein said permanent visual impairment benefit of said vision protection policy provides for at least one payment to be made in response to a policy participant being diagnosed with a visual impairment for which there is no, or substantially no, reasonable medical prognosis of recovery.
